(19) United States
(12) Patent Application Publication
(10) Pub. No.: US 2001/0015829 A1
(43) Pub. Date: Aug. 23, 2001

(54) Apparatus having a scanning device which is detachable from the apparatus

(76) Inventor: Johann Veigl, Vienna (AT)

Correspondence Address: Corporate Patent Counsel, U.S. Philips Corporation, 580 White Plains Road, Tarrytown, NY, 10591, US

(21) Appl. No.: 09/761,252

(22) Filed: Jan. 16, 2001

(30) Foreign Application Priority Data
Jan. 19, 2000 (EP) 00890014.4

(51) Int. Cl. H04N 1/04

(52) U.S. Cl. 358/474; 358/473; 358/496

(57) ABSTRACT

In an apparatus (1) having a scanning device (30) for scanning a record carrier (11) to be scanned the scanning device (30) is accommodated in a separate housing (31) and the scanning device (30) is detachable from the apparatus (1), by means of which scanning device (30) a record carrier (11) can be scanned both in a first mode of operation, in which said device (30) is attached to the apparatus (1), and in a second mode of operation, in which said device (30) is detached from the apparatus (1), and withdrawal means (33) have been provided, for withdrawing each time one record carrier (11) to be scanned from a stack (5) of record carriers to be scanned, and drive means (40, 41) have been provided, for driving a withdrawn record carrier (11) to be scanned in the apparatus (1), the withdrawal means (33) and the drive means (40, 41) being accommodated in the separate housing (31) of the scanning device (30), which drive means (40, 41) can be placed onto the stationary record carrier (11) to be scanned and can be rolled over the record carrier (11) to be scanned in the second mode of operation.

The invention relates to an apparatus as defined in the opening part of claim 1.

Such an apparatus is commercially available in several versions and is consequently known. The known apparatus is a so-called facsimile apparatus having a scanning device, often also referred to as a scanner, which is removable from the facsimile apparatus. In the known apparatus the withdrawal means for withdrawing each time one record carrier to be scanned and the drive means for driving a withdrawn record carrier to be scanned are accommodated in the apparatus and are inseparably connected to the apparatus. In addition, the scanning device has mutually coaxial rollers for scanning each time one record carrier to be scanned, which rollers in the second mode of operation can be placed onto a stationary record carrier to be scanned and can roll over the record carrier to be scanned, in order to drive a tacho generator incorporated in the scanning device and intended for generating a time reference signal, as is commonly known from such scanning devices which are to be moved by hand over a record carrier to be scanned. The provision of the withdrawal means and the drive means in the known apparatus and the provision of separate rollers in the scanning device which is removable from the apparatus is comparatively intricate, which leads to comparatively high production costs for the known apparatus and which results in a construction which is unfavorable as regards the required space, which is unfavorable in view of an apparatus whose construction is as compact and as simple as possible.

It is an object of the invention to preclude the afore-mentioned problems and to provide an improved apparatus of the type defined in the opening part of claim 1.

According to the invention an apparatus as defined in the opening part of claim 1 has the characteristic features as defined in the characterizing part of claim 1.

Owing to the provision of the characteristic features in accordance with the invention a substantially simpler construction is obtained in comparison with the aforementioned known apparatus, which construction has the additional advantage that it requires less space as compared with the known apparatus. A further advantage is that the productions costs are reduced.

In an apparatus in accordance with the invention the withdrawal means for withdrawing each time one record carrier to be scanned and the drive means for driving a withdrawn record carrier to be scanned can each be formed by at least one circular disc. However, it has proved to be very advantageous when the apparatus in accordance with the invention, in addition, has the characteristic features as defined in claim 2. This solution has the advantage of a reliable and particularly simple and compact construction. In connection with the principle of this solution reference may be made to, for example, the patent document U.S. Pat. No. 5,820,121 A.

The above-mentioned as well as further aspects of the invention will become apparent from the embodiment described hereinafter by way of example and will be elucidated with reference to this example.

The invention will now be described in more detail with reference to the drawings, which show an embodiment given by way of example but to which the invention is not limited.

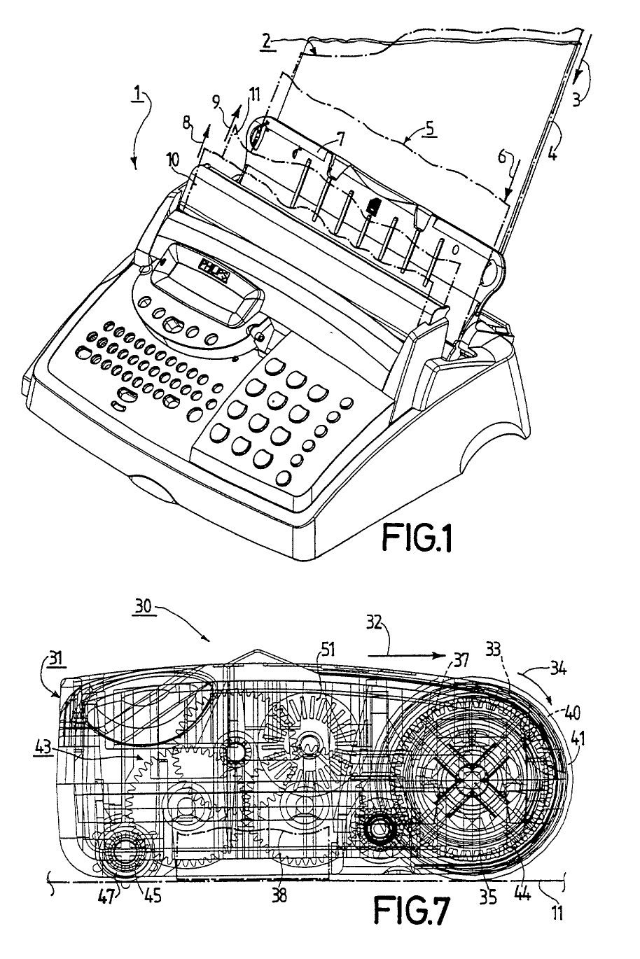

FIG. 1 is an oblique plan view of an apparatus in accordance with the invention in accordance with an embodiment of the invention, a scanning device of the apparatus in accordance with the invention being removed from the apparatus and, as a consequence, not being shown in FIG. 1.

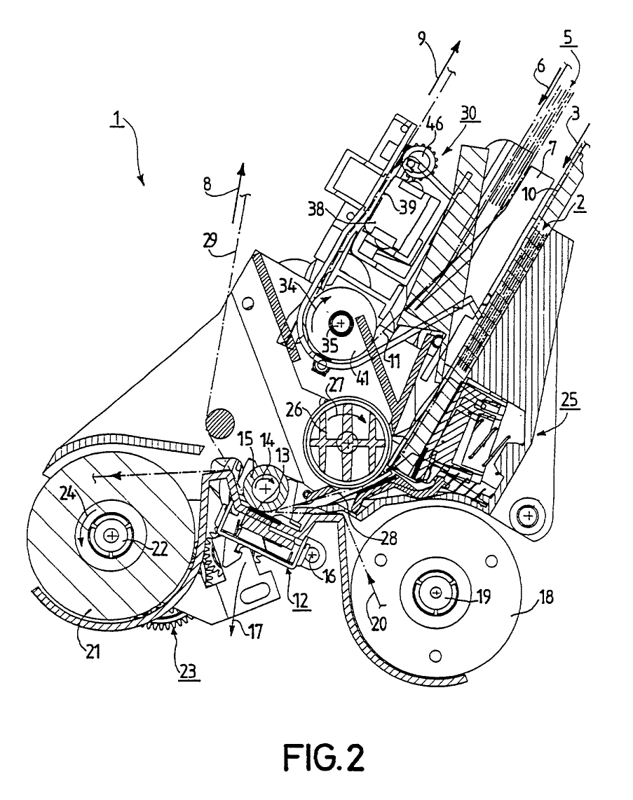

FIG. 2 is a partly diagrammatical cross-sectional view which shows a relevant part of the apparatus shown in FIG. 1, which part of the apparatus includes the scanning device which is removable from the apparatus.

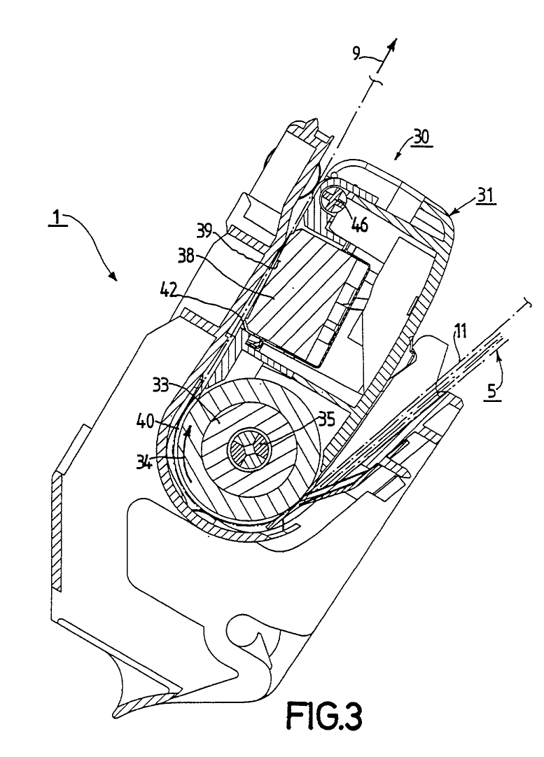

FIG. 3 is a cross-sectional view which shows a part of the apparatus of FIGS. 1 and 2 to an enlarged scale as compared with FIG. 2, which part includes the scanning device which is removable from the apparatus, shown in a first operating position in the apparatus.

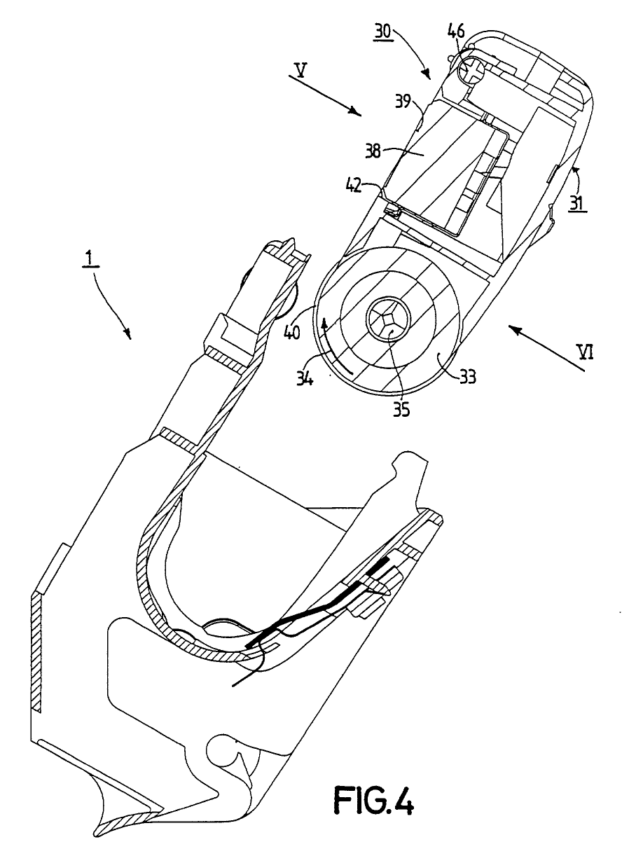

FIG. 4, in the same way as FIG. 3, shows the part of the apparatus of FIGS. 1 and 2, the scanning device being shown in an intermediate position removed from the apparatus.

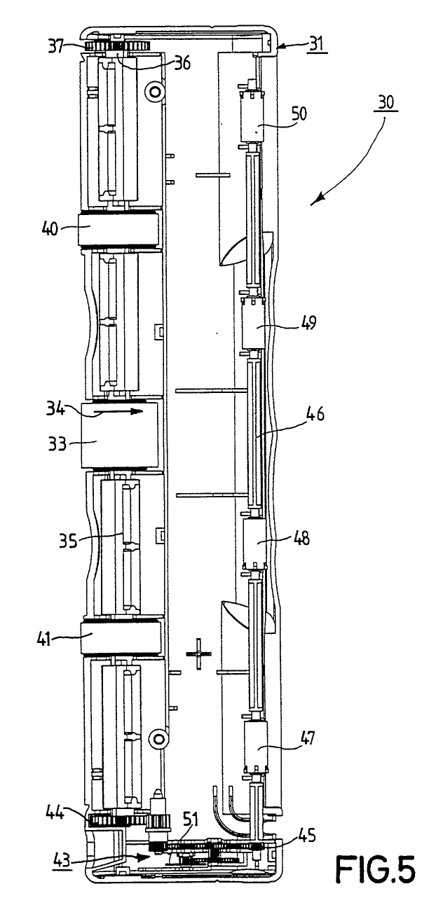

FIG. 5 shows the scanning device of the apparatus of FIGS. 1 to 4 in a view as indicated by the arrow V in FIG. 4.

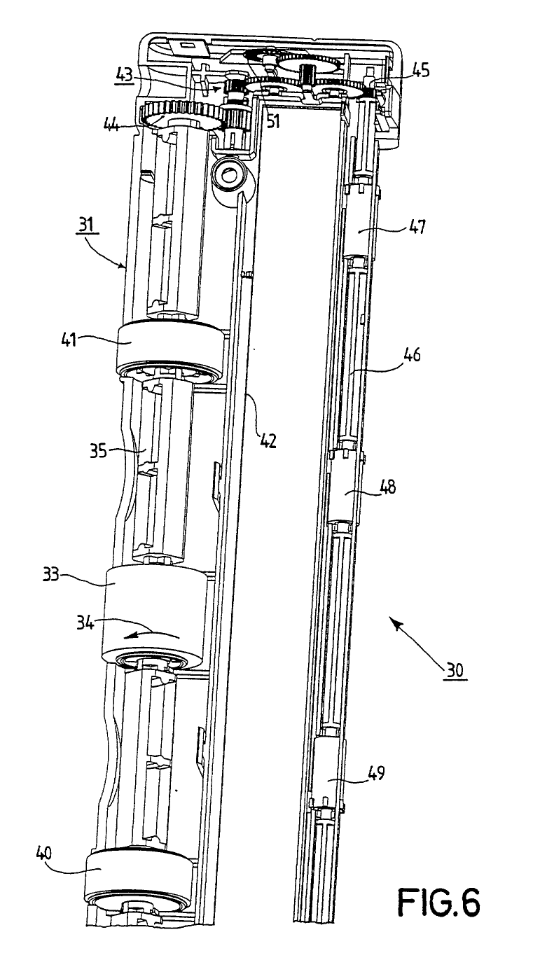

FIG. 6 shows a part the scanning device of the apparatus of FIGS. 1 to 4 in a view as indicated by the arrow VI in FIG. 4.

FIG. 7 is a partly sectional side view which shows the scanning device of the apparatus of FIGS. 1 to 4 in a second operating position.

FIG. 1 shows an apparatus 1 in accordance with an embodiment of the invention. In the present case, the apparatus 1 is a facsimile apparatus, hereinafter briefly referred to as the apparatus 1.

A first stack 2 of record carriers to be printed can be loaded into the apparatus 1 in a direction indicated by an arrow 3, which stack 2 is shown in dash-dot lines in FIGS. 1 and 2. In its loaded condition the stack 2 lies on a supporting plate 4 of the apparatus 1. Moreover, a second stack 5 of record carriers to be scanned can be loaded into the apparatus 1 in a direction indicated by an arrow 6. The second stack 5 is also shown in dash-dot lines. In its loaded condition the stack 5 lies against a guide plate 7 of the apparatus 1, which guide plate 7 is connected to additional means with the aid of which load means for exerting a load on the first stack 2 of record carriers to be printed in the leading-edge areas of these record carriers can be reset, but this will not be described any further hereinafter. The currently uppermost record carrier to be printed can be withdrawn from the stack 2 of record carriers to be printed and can subsequently be fed to a printing roller and thereupon out of the apparatus 1 in a direction indicated by an arrow 8, as is shown in dash-dot lines in FIG. 1. Likewise, the currently uppermost record carrier to be scanned can be withdrawn from the second stack 5 of record carriers to be scanned and can be fed to a scanning device of the apparatus 1, which scanning device is not shown in FIG. 1 and by means of which it is possible to scan the graphic content of the respective record carrier to be scanned, after which the record carrier just scanned can be fed out of the apparatus 1 in the direction indicated by an arrow 9, as is also shown in dash-dot lines in FIG. 1.

The other parts of the apparatus 1 which are shown in FIG. 1, such as the housing, a telephone keypad, an alphanumeric keypad, a display device and the like, will not be described in any further detail.

The apparatus 1 is constructed to print a record carrier to be printed, which can be fed out of the apparatus 1 in the direction indicated by the arrow 8. The apparatus 1 is further constructed to scan a record carrier 11 to be scanned, which can be fed out of the apparatus 1 in the direction indicated by the arrow 9. This construction will be described in more detail with reference to FIG. 2.

The apparatus 1 includes a printing device 12 having a print head 13. The print head 13 is a thermal print head which is substantially strip-shaped and by means of which it is possible to print in a point-by-point fashion. This printing is effected on a record carrier 10 to be printed, i.e. a blank sheet. The record carrier 10 to be printed can be driven in steps with the aid of a printing roller 15 which is drivable in a direction indicated by an arrow 14 (i.e. clockwise). The printing roller 15 cooperates with the print head 13. The printing roller 15 is mounted in the apparatus 1 so as to be rotatable, but apart from that it is stationary. The printing device 12 is held against the printing roller 9 with the aid of spring means, not shown, the print head 13 thus being urged against the printing roller 15 under spring load. The printing device 12 including its print head 13 is pivotable about an axis 16 and is movable away from the printing roller 15 in a direction indicated by an arrow 17. The movement of the printing device 12 away from the printing roller 15 is effected with the aid of an actuating device which is not shown in FIG. 1 and which can be driven by means of the printing roller 15.

In the apparatus 1 a thermal-transfer printing process can be performed by means of the print head 13. In this thermal-transfer printing process a thermal-transfer foil is heated in a point-by-point fashion with the aid of the print head 13, as a result of which a wax-like dye carried by the thermal transfer foil is transferred to the record carrier 10 to be printed. Said thermal transfer foil is wound onto a first reel 18, the first reel 18 with the supply of thermal transfer foil being carried by a supply mandrel 19. From the first reel 18 the thermal transfer foil is led to a second reel 21 along a feed path 20 shown as a dash-dot line, which second reel is carried by a take-up mandrel 22. The take-up mandrel 22 can be driven by the printing roller 15 in a direction indicated by an arrow 24 via a transmission gear 23, which is shown partly in FIG. 2.

In order to print a record carrier 10 to be printed such a record carrier 10 to be printed should be withdrawn from a blank-sheet feeder 25 which contains a stack 2 of such record carriers to be printed, i.e. it should be separated from the stack. For this purpose, the apparatus 1 has a blank-sheet withdrawal roller 26, which is rotationally drivable in a direction indicated by an arrow 27, i.e. clockwise. The currently uppermost record carrier to be printed can be withdrawn from the first stack 2 in the blank-sheet feeder 25 with the aid of the blank-sheet withdrawal roller 26 and be fed into the area between the print head 12 and the printing roller 15. As soon as a record carrier 10 to be printed has reached the printing roller 15, the record carrier 10 to be printed is fed further by means of the printing roller 15, the blank-sheet withdrawal roller 26 then being out of driving engagement, as is already known per se from such apparatus since long. A record carrier 10 to be printed is fed between the blank-sheet feeder 25 and the printing roller 15 along a feed path 28 shown as a dash-dot line in FIG. 2. After the record carrier 10 to be printed has been printed the printed record carrier 10 is fed along a feed path 29, which is likewise shown as a dash-dot line in FIG. 2, and is then fed out of the apparatus 1 in the direction indicated by the arrow 8.

The apparatus 1 further includes a scanning device 30, by means of which a record carrier 11 to be scanned, i.e. an original document, can be scanned in order to convert the graphic information on the record carrier 11 to be scanned, for example alphanumeric characters, into digital signals. In FIG. 2 the scanning device 30 is shown only diagrammatically. Conversely, FIGS. 3 to 7 illustrate the actual construction of the scanning device 30.

The scanning device 30 is accommodated in a separate housing 31. In this way, it is achieved that the scanning device 30 forms a separate unit and can consequently be separated readily and simply from the apparatus 1 so as to be removed from the apparatus 1. In a first mode of operation, in which the scanning device 30 is connected to the apparatus 1, as is illustrated in FIG. 2, as well as in a second mode of operation, in which it is separated from the apparatus 1, as is illustrated in FIG. 1, said scanning device can scan a record carrier 11 to be scanned. In the first mode of operation as shown in FIG. 3 and also in FIG. 2, the record carrier 11 to be scanned can be fed past the scanning device 30, which is immobile in the apparatus 1, with the aid of drive means to be described in more detail hereinafter. In the second mode of operation the scanning device 30 can be moved by hand over the stationary record carrier 11 to be scanned, namely in a direction of movement indicated by an arrow 32 in FIG. 7.

In order to enable scanning of a record carrier 11 to be scanned in the first mode of operation illustrated in FIG. 3, such a record carrier 11 to be scanned must be withdrawn from the second stack of record carriers to be scanned. For this purpose, the apparatus 1 has an original-document withdrawal roller 33, which is rotationally drivable in a direction indicated by an arrow 34 (i.e. clockwise). The original-document withdrawal roller 33 is mounted so as to be rotatable with the aid of a spindle 35. As is apparent from FIGS. 5 and 6, a drive gear wheel 37 is locked in rotation to the spindle 35 in the area of an end 36 of the spindle 35. With the aid of the drive gear wheel 37 the original-document withdrawal roller 33 can be driven in steps in the direction indicated by the arrow 34, namely with the aid of apparatus-mounted drive means, which are neither shown nor described any further. As is shown in FIGS. 2 to 7, the original-document withdrawal roller 33 provided as withdrawal means is accommodated in the separate housing 31 of the scanning device 30, which withdrawal roller serves for withdrawing a record carrier 11 to be scanned from the second stack 5 of record carriers to be scanned, the leading edges of the record carriers to be scanned of this stack 5 being situated in the area of the withdrawal means, i.e. in the area of the original-document withdrawal roller 33, as can be seen in FIGS. 2 and 3.

In order to enable the actual scanning of a record carrier 11 to be scanned after withdrawal of this record carrier 11 to be scanned, the withdrawn record carrier 11 to be scanned should be driven stepwise in the apparatus 1, the withdrawn record carrier 11 to be scanned being fed to an elongate scanning unit 38 during this driving process. The scanning unit 38 includes a photoelectrically operating scanning strip 39, which is held in close contact with a record carrier 11 to be scanned, namely in that spring means, not shown, urge the scanning unit 38 towards the record carrier 1 1 to be scanned.

For driving a withdrawn record carrier 11 to be scanned the apparatus 1 has two original-document drive rollers 40 and 41, which serve as drive means for driving a withdrawn record carrier 11 to be scanned in the apparatus 1, in order to feed the withdrawn record carrier 11 to be scanned to the scanning unit 38 and move it past the scanning device 30, i.e. past the scanning unit 38. As is apparent from FIGS. 2 to 7, the two original-document drive rollers 40 and 41 provided as drive means are also accommodated in the separate housing 31 of the scanning device 30. Like the original-document withdrawal roller 33, the two original-document drive rollers 40 and 41 provided as drive means are also rotatably mounted with the aid of the spindle 35 and are coaxial with the original-document withdrawal roller 33. The two original-document drive rollers 40 and 41 consist of a material having a comparatively high coefficient of friction and have a diameter which is slightly greater than the diameter of the original-document withdrawal roller 33. Due to this advantageous construction it is achieved that in the second mode of operation as illustrated in FIG. 7 the two original-document drive rollers 40 and 41 provided as drive means can be placed onto the stationary record carrier 11 to be scanned and can roll over the record carrier 11 to be scanned while the scanning device 30 is moved over the record carrier 11 to be scanned in the direction of movement 32. As a result of the fact that the two original-document drive rollers 40 and 41 are rotatably mounted with the aid of the spindle 35 it is further achieved that the two original-document drive rollers 40 and 41 are also rotationally drivable with the aid of the drive gear wheel 37. Further details on the construction of the spindle 35 and the original-document withdrawal roller 33 as well as the two original-document drive rollers 40 and 41 can be found in, for example, the patent document U.S. Pat. No. 5,820,121 A.

As regards the construction of the scanning device 30 it is to be noted the housing 31 of the scanning device 30 has an elongate window 42 (for this, see in particular FIG. 6), through which window 42 the elongate scanning unit 38 extends, thus enabling the photoelectrically operating scanning strip 39 of the scanning unit 38 to cooperate correctly with a record carrier 11 to be scanned.

Furthermore, it is to be noted that the housing 31 of the scanning device 30 accommodates a gear wheel transmission 43, which is in driving engagement both with a coupling gear wheel 44, which is coaxial with the drive gear wheel 37 and is mounted on the facing end of the spindle 35, and with a coupling pinion 45. The coupling pinion 45 is mounted on a further spindle 46, which carries four servo rollers 47, 48, 49 and 50. A tacho disc 51 of a tacho generator of the scanning device 30 is in driving engagement with the gear wheel transmission 43. In this way, the original-document drive rollers 40 and 41 as well as the servo rollers 47, 48, 49 and 50 are in driving engagement with the tacho disc 51 of a tacho generator by means of the gear wheel transmission 43, which has the known advantage that in the operational situation in which the original-document drive rollers 40 and 41, which lie in front when the scanning device 30 is moved in the direction of movement 32, have already left a stationary record carrier 11 to be scanned, the tacho disc 51 of the tacho generator included in the scanning device 30 is still driven with the aid of the servo rollers 47, 48, 49 and 50 and a part of the gear wheel transmission 43, so that subsequently also a time reference signal is generated in this operational situation and thus a correct scanning of a record carrier to be scanned is guaranteed also in its end portion. In the present apparatus 1 the withdrawal means for withdrawing a record carrier 11 to be scanned, i.e. the original-document withdrawal roller 33, and the drive means for driving a withdrawn record carrier 11 to be scanned in the apparatus 1, i.e. the two original-document drive rollers 40 and 41 are advantageously mounted in the scanning device 30 which is removable from the apparatus 1. Thus, a simple, space-saving and compact construction of the entire apparatus is achieved because separate withdrawal means and separate drive means in the apparatus are not necessary. By accommodating the withdrawal means and the drive means in the scanning device 30 it is further achieved that the drive means, i.e. two original-document drive rollers 40 and 41, can be used not only for driving a record carrier to be scanned in the apparatus 1 but also for a rolling and driving function during the movement of the scanning device 30 over a stationary record carrier 11 to be scanned in the second mode of operation of the scanning device 30, the two original-document drive rollers 40 and 41 driving a tacho disc of a tacho generator for the generation of a time reference signal, which is indispensable in this case.

As regards the drive means for the printing roller 15, the take-up mandrel 22, the blank-sheet withdrawal roller 26 and the original-document drive rollers 40 and 41, as well as the original-document withdrawal roller 33, reference is made to the European priority patent application of Dec. 23, 1999 having the application number 99 890 402.3, whose subject matter is incorporated herein by reference.

The invention is not limited to the embodiment described hereinbefore by way of example. In a modification of the apparatus described hereinbefore it is alternatively possible to provide, for example, on a common spindle in a scanning device which is removable from the apparatus two original-document withdrawal rollers and three or more original-document drive rollers in the scanning device. Moreover, it is not strictly necessary in an apparatus in accordance with the invention to equip the scanning device which is removable from the apparatus with so-called servo rollers.

1. An apparatus
having a scanning device for scanning a record carrier to be scanned, which scanning device is accommodated in a separate housing and which includes a scanning unit and which is detachable from the apparatus and by means of which a record carrier to be scanned can be scanned both in a first mode of operation, in which said scanning device is attached to the apparatus, and in a second mode of operation, in which it is detached from the apparatus, in which first mode of operation the record carrier to be scanned is movable past the stationary scanning device in the apparatus with the aid of drive means and in which second mode of operation the scanning device is movable by hand over the stationary record carrier to be scanned, and
having withdrawal means for withdrawing each time one record carrier to be scanned from a stack of record carriers to be scanned, of which stack the record carriers to be scanned are situated with their leading edges in the area of the withdrawal means, and
having drive means for driving a withdrawn record carrier to be scanned in the apparatus in order to move the withdrawn record carrier to be scanned to the scanning device and past the scanning device,
characterized in that the withdrawal means for withdrawing a record carrier to be scanned and the drive means for driving a withdrawn record carrier to be scanned are accommodated in the separate housing off-ear mode the scanning device.

2. An apparatus as claimed in claim 1, characterized in that
the withdrawal means for withdrawing each time one record carrier to be scanned and the drive means for driving a withdrawn record carrier to be scanned each comprise at least one roller and these rollers are arranged to be coaxial with one another.

3. An apparatus as claimed in claim 1, characterized in that in the second mode of operation the drive means can be placed onto the stationary record carrier to be scanned and can be rolled over the record carrier to be scanned.
